(19) United States
(12) Patent Application Publication
(10) Pub. No.: US 2008/0045413 A1
(43) Pub. Date: Feb. 21, 2008

(54) Method for manufacturing activated carbon fiber products

(75) Inventors: Tse-Hao Ko, Taichung (TW); Yu-Tang Chen, Taichung (TW); Chung-Kai Pan, Taichung (TW)

Correspondence Address: Venable LLP;Raymond J. Ho, 575 7th Street NW, Washington, DC, 20004-1601, US

(73) Assignee: Feng Chia University, Taichung (TW)

(21) Appl. No.: 11/543,098

(22) Filed: Oct. 5, 2006

(30) Foreign Application Priority Data
Aug. 16, 2006 (TW) 095130058

(51) Int. Cl. C01B 31/08

(52) U.S. Cl. 502/418

(57) ABSTRACT

A method for manufacturing an activated carbon fiber product comprising the steps of (a) providing an oxidized fiber product, and (b) activating the oxidized fiber product in the presence of a chemical reagent selected from a group consisting of an acid, an ammonium salt, a metallic compound, and a combination thereof. The method provides an activated carbon fiber product with a high specific surface at a relatively low temperature. The method especially provides an activated carbon fabric suitable for use as an electrode of an electric double layer capacitor.

This application claims priority to Taiwan Patent Application No. 095130058 filed on Aug. 16, 2006.

### CROSS-REFERENCES TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The subject invention relates to a method for manufacturing an activated carbon fiber product, especially to a method for manufacturing an activated carbon fiber product with a high specific surface.

2. Descriptions of the Related Art

The specific surface area (BET value) is an important index for determining the utility of an activated carbon fiber product. An activated carbon fiber product that has a specific surface up to 1000 m²/g has a higher value in commercial application.

Because an activated carbon fiber that is manufactured from polyacrylonitrile (“PAN”) fiber excels in absorption and mechanical strength, it is widely used in the industry. U.S. Pat. No. 4,362,646, issued to Ikegami et al., disclosed PAN-based activated carbon fibers manufactured from PAN fibers as superior in mechanical strength and absorption to pitch-based, cellulose-based and phenol resin-based activated carbon fibers due to the nitrogen atoms contained therein. It is generally desirable to weave PAN-based activated carbon fibers into fabrics for filtering undesired impurities for uses, such as in the treatment of waste gas or waste water. However, if PAN-based activated carbon fibers are to be woven into fabrics, the following complicated process is commonly required: PAN-based fiber bundles→oxidization→activation→activated carbon fiber bundles→carding→spinning→activated carbon yarn→weaving→activated carbon fabrics. However, because the above PAN-based activated carbon fibers manufactured from PAN fibers exhibit poor elongation (less than 1.5%), they are easily broken in the carding, spinning and weaving processes (especially weaving process), and therefore are only suitable for forming fiber bundles, non-woven fabrics, fiber papers or felts and not for forming activated carbon fabrics.

To avoid the above-mentioned breakages due to the carding, spinning and/or weaving processes, Japan Laid-open Patent No. 60-231834 discloses a process for preparing activated carbon fabrics by directly using fabrics as raw materials. The fabric is woven from a first fiber that includes cellulose or phenol resin fiber, and a second fiber. The first fiber can be activated, thereby, allowing absorption in the resulting activated carbon fabrics. However, as the mechanical strength of first fibers will, during their activation process, degrade, the resulting activated carbon fabrics cannot exhibit the desired mechanical strength.

Regarding the above problem of mechanical strength, U.S. Pat. No. 6,156,287, which was issued to one of the co-inventors of the subject invention, discloses a method for manufacturing an activated carbon fabric with an improved mechanical strength from a PAN-based oxidized fabric. In this method, a PAN-based oxidized fabric is activated by exposure to heat that ranges from 700 to 1000° C. However, according to the disclosures of U.S. Pat. No. 6,156,287, an activation temperature up to 1000° C. is required to manufacture an activated carbon fabric with a specific surface area (BET value) of 1000 m²/g. The disclosure of U.S. Pat. No. 6,156,287 is incorporated hereinto for reference.

Although the method disclosed in U.S. Pat. No. 6,156,287 can provide proper activated carbon fabrics, it must be operated at a temperature of 1000° C. to manufacture activated carbon fabrics with a specific surface of 1000 m²/g. The high activation temperature not only limits the operation but also increases the energy demand. Thus, a method that provides activated carbon fabrics with a desired specific surface under a relatively low activation temperature is desired, so as to effectively reduce the energy consumption as well as the production cost.

The subject invention meets the above demand and provides a method comprising carrying out an activation treatment at a relative low temperature, and thus, can provide an activated carbon fiber product with a specific surface of 1000 m²/g or higher at an activation temperature of below 1000° C. The subject invention further provides an activated carbon fiber product with a high capacitance suitable for use in an electrode of an electric double layer capacitor, so as to provide an electric double layer capacitor with a high capacitance.

### SUMMARY OF THE INVENTION

One object of the subject invention is to provide a method for manufacturing an activated carbon fiber product. The method comprises the following steps:

(a) providing an oxidized fiber product; and
(b) activating the oxidized fiber product in the presence of a chemical reagent selected from a group consisting of an acid, an ammonium salt, a metallic compound, and a combination thereof.

Another object of the subject invention is to provide a method for manufacturing an activated carbon fiber product. The method comprises the following steps:

(a) providing an oxidized fiber product; and
(b) activating the oxidized fiber product in the presence of a chemical reagent selected from a group consisting of phosphoric acid, potassium hydroxide, zinc chloride, ammonium chloride, boric acid, ammonium sulfate, ammonium dihydrogen phosphate, potassium permanganate, potassium bicarbonate, and a combination thereof.

Another object of the subject invention is to provide a method for manufacturing a PAN-based activated carbon fiber product. The method comprises the following steps:

(a) providing a PAN-based oxidized fiber product; and
(b) activating the PAN-based oxidized fiber product in the presence of a chemical reagent selected from a group consisting of phosphoric acid, potassium hydroxide, zinc chloride, ammonium chloride, boric acid, ammonium sulfate, ammonium dihydrogen phosphate, potassium permanganate, potassium bicarbonate, and a combination thereof.

Yet another object of the subject invention is to provide a method for manufacturing a PAN-based activated carbon fiber product. The method comprises the following steps:

(a) providing a PAN-based oxidized fiber product; and
(b) activating the PAN-based oxidized fiber product in the presence of a chemical reagent and an activating gas, wherein the activating gas is selected from a group consisting of air, carbon dioxide, steam, and a combination thereof. The chemical reagent is selected from a group consisting of phosphoric acid, potassium hydroxide, zinc chloride, ammonium chloride, boric acid, ammonium sulfate, ammonium dihydrogen phosphate, potassium permanganate, potassium bicarbonate, and a combination thereof.

According to the above-mentioned methods of the subject invention, the activation can be conducted at a relative low temperature by utilizing the chemical reagent, so as to produce an activated carbon fiber product with a desired high specific surface from an oxidized fiber product at a lower manufacturing cost. The oxidized fiber product can be in the form of fabric, felt, paper, or fiber bundle. The method of the subject invention can provide, in addition to the activated carbon fiber product for use in filtering undesired impurities, an activated carbon fiber product suitable for use in the manufacture of an electrode in order to provide an electric double layer capacitor with a high capacitance.

The detailed technology and preferred embodiments implemented for the subject invention are described in the following paragraphs for people skilled in this field to well appreciate the features of the claimed invention.

### DESCRIPTION OF THE PREFERRED EMBODIMENT

According to the subject invention, the method for manufacturing an activated carbon fiber product requires an oxidized fiber product with a corresponding form as the raw material. The oxidized fiber product is activated in the presence of a chemical reagent at a relative low activation temperature to provide a desired activated carbon fiber product. That is, if the desired product is an activated carbon fiber, an oxidized fiber is used as the raw material. If an activated carbon fiber felt is desired, an oxidized fiber felt is used as the raw material. And if the desired product is an activated carbon fabric, an oxidized fabric is used as the raw material.

In the method of the subject invention, any suitable oxidized fiber products can be used as the raw material. It is preferred that the oxidized fiber contained in the oxidized fiber product has a limiting oxygen index (“L.O.I”) of at least 40, and more preferably from 40 to 80. Moreover, the carbon content of the oxidized fiber preferably ranges from 40 wt % to 80 wt %. One oxidized fiber product suitable for use in the subject invention is a PAN-based oxidized fiber that is prepared from PAN as a major component. The PAN-based oxidized fibers can be produced by such as heating the PAN fibers under an oxygen-containing atmosphere at 150 to 400° C.

Another embodiment of the oxidized fiber product suitable for use in the subject invention is a PAN-based oxidized fabric prepared from PAN as the raw material, e.g., commercially available fireproof fabrics for fire-fighting and heat insulating. The fireproof fabrics are manufactured, for example (but not limited to) by subjecting PAN bundles (each bundle contains at least 600 fibers) to an oxidation treatment to obtain PAN oxidized fibers, and then forming the oxidized fibers to into fabrics by a weaving or non-weaving method. The oxidation treatment comprises calendaring and simultaneously heating the PAN bundles at a temperature ranging from 150 to 400° C. for 30 minutes to 20 hours to allow for cyclization reaction. The oxidation treatment leads to the formation of ladder polymers to form PAN stabilized (i.e., oxidized) fibers with a cyclization index of at least 40%, an oxygen content of at least 6%, and a density of 1.33 to 1.55 g/cm³. The method for manufacturing the PAN-based oxidized fabric suitable for use in the subject invention can be found in U.S. Pat. No. 6,156,287. The relevant contents disclosed in U.S. Pat. No. 6,156,287 are incorporated hereinto for reference.

The activation treatment of the subject invention is conducted in the presence of a chemical reagent selected from the group consisting of an acid, an ammonium salt, a metallic compound, and a combination thereof. Any acids that can provide hydrogen ions can be used in the subject invention. The acid is preferably selected from the group consisting of oxalic acid, phosphoric acid, carbonic acid, boric acid, sulfuric acid, and a combination thereof, and more preferably is phosphoric acid. The ammonium salts suitable for use in the subject invention comprise ammonium chloride, ammonium sulfate, and diammonium hydrogen phosphate. The method of the subject invention also can be carried out by utilizing any metallic compound that can provide a metal component as the chemical reagent, such as a hydroxide or a salt. Preferably, the salt is selected from the group consisting of sulfate, phosphate, permanganate, carbonate, bicarbonate, halide, and a combination thereof. It is also preferred that the metallic compound comprises a metal component selected from the group consisting of potassium, sodium, calcium, manganese, chromium, iron, zinc, silver, platinum, and a combination thereof, more preferably comprises a metal component selected from the group consisting of potassium, sodium, calcium, manganese, chromium, iron, zinc, and a combination thereof. The activation treatment involved in the subject invention is preferably conducted in the presence of a chemical reagent selected from the group consisting of phosphoric acid, potassium hydroxide, zinc chloride, ammonium chloride, boric acid, ammonium sulfate, ammonium dihydrogen phosphate, potassium permanganate, potassium bicarbonate, and a combination thereof.

Alternatively, the oxidized fiber product can be treated with the chemical reagent before the activation treatment. For example, the oxidized fiber product is immersed in an aqueous solution of the chemical reagent to carry the chemical reagent required for the activation treatment. Specifically, in an embodiment wherein an acid is used as the chemical reagent, the oxidized fiber product is immersed in a 0.4 to 60 wt % phosphoric acid solution for an appropriate time period (e.g., from 5 minutes to 48 hours) with an optional thermal treatment at a temperature ranging from 40 to 120° C., followed by drying. In an other embodiment wherein a metallic compound is used as the chemical reagent, the oxidized fiber product is immersed in a 0.01 to 1M potassium hydroxide solution for an appropriate time period (e.g., from 1 minute to 24 hours), followed by driving.

Afterwards, the activation treatment involved in the subject invention is conducted in a high temperature furnace by introducing an activating gas into the furnace in the presence of the foregoing chemical reagents. It is preferred that the activating gas is selected from the group consisting of air, carbon dioxide, steam, and a combination thereof. It is even more preferable for a stream to be used as the activating gas. In general, the activation treatment is carried out at a temperature ranging from 600 to 1000° C., preferably from 750 to 950° C., and more preferably from 850 to 950° C.

Optionally, a suitable protective gas may be used to protect the inlet and outlet of the high temperature furnace during activation treatment. For example, if PAN-based oxidized fabrics are used as the raw materials, a protective gas such as nitrogen, helium, or argon, can be used to protect the inlet and outlet of the high temperature furnace to avoid self-combustion of the PAN-based oxidized fabrics caused by volatilization of small molecules from the fabrics during the activation treatment.

Moreover, after the activation treatment, an acid is optionally used to neutralize the basicity remaining in the fiber product. The aforementioned neutralization treatment is especially preferable for the embodiments wherein a metallic hydroxide is used as the chemical reagent for the activation treatment. For example, in the embodiment wherein a 0.01 to 1M potassium hydroxide solution is used to immerse the oxidized fiber product to provide the chemical reagent for the activation treatment, the fiber product is treated, after the activation treatment, with an acid washing of 0.1 to 10 M HCl solution to remove the basicity remaining therein. This acid washing is followed by a water washing and drying to provide an activated carbon fiber product with an improved performance.

As compared to a conventional activation treatment that does not utilize a chemical reagent (e.g., the activation treatment disclosed in U.S. Pat. No. 6,156,287), the activation treatment of the subject invention, which is conducted in the presence of a chemical reagent, provides an activated carbon fiber product with a high specific surface at a relative low activation temperature. Specifically, the method of the subject invention provides an activated carbon fiber product with a specific surface of 1000 m²/g or higher at an activation temperature of below 1000° C. The subject invention can provide, in addition to the activated carbon fiber product for filtering undesired impurities, an activated carbon fiber product suitable for the manufacturing of an electrode as an activated carbon fabric, an activated carbon fiber felt, or an activated carbon fiber paper, to provide an electric double layer capacitor with a high capacitance.

The following examples are illustrated to further describe the subject invention. In these examples, the capacitance of the capacitor is tested by a three-pole capacitor test board. Graphite is used in the working electrode and auxiliary electrode as the current collector, while silver/silver chloride is used as the reference electrode. While assembling, the activated carbon fabric that is treated with the activation is cut into a square, 1 cm×1 cm, and placed on the current collector of the working electrode as the electrode material. A separate membrane (PP fiber membrane) is placed onto and fixed to the carbon fabric. Then, the above assembly is immersed in a 1M H₂SO₄ electrolyte and tested. The equipments and methods for testing the various properties and capacitance of the resulting activated carbon fabrics are described as follows:

(1) Specific surface (BET) analysis:
Equipment: Micromeritics ASAP2020 (manufactured by Micromeritics Instrument Company)
Test method: The sample is placed in the equipment. After the degasification at a high temperature (360□), the adsorption gas (nitrogen gas) is introduced into the equipment. The experimental temperature and pressure are held at 77° K and 760 mmHg, respectively.
   (2) Direct current charge and discharge test:
Equipment: BaSyTec Battery Test System Charge and Discharge Equipment (manufactured by BaSyTec GmbH)
Test method: Galvanostatic charge and discharge
Current: 1 mA
Voltage range of charge and discharge: 0 to 0.75 V
Electrolyte: 1M H₂SO₄
The calculation of discharge capacitance (ΔC):

$$Δ C = \frac{( I \times Δ T )}{Δ V}$$

wherein, I: discharge current (A); □T: unit time (sec); □V: potential drop (V)

### (3) Capacity test (C):

Equipment: CH Instruments Electrochemical Analyzer Potentiostat (manufactured by CH Instruments Company, Model CH1627B)
Test method: Cycle voltammogram. In this experiment, pre-scanning is first conducted by using a fix scanning potential (mV/sec) to set the open circuit potential to zero. Then, the cycle voltammogram is conducted at a stable working potential for four cycles.
Scanning potential: 6 mV/sec
Potential range: 1 to 0.75 V
The calculation of capacitance (C):

$$C = \frac{i}{v}$$

C: capacitance (F); i: current (A); v: scanning rate (mV/sec)

### (4) True Density

Equipment: Accupyc 1330 Pycnometwr True Densimeter (manufactured by Micromeritics Instrument Company)
Test method: A dried sample is placed in the container of the true densimeter and weighed. The high pressure helium gas is introduced into the true densimeter. After an equilibrium status is achieved, ideal gas equation (PV=nRT) is used to calculate the sample volume. Then, the average value of the sample density is obtained.

### (6) Carbon yield

Equipment: Semi-Micro Precision Balance (manufactured by Sartorius AG)
Test method: The oxidized fiber sample is weighed after being dried in an oven at 120° C. for 12 hours to obtain its absolute dry weight. After the activation treatment, the obtained activated carbon fiber sample is washed with an acid or water and weighed after drying in an oven at 120° C. for 12 hours to obtain its absolute dry weight.
The calculation of the carbon yield (wt %):
Carbon yield (wt %)=(absolute dry weight of the activated carbon fiber sample/absolute dry weight of the oxidized fiber sample)×100%

### EXAMPLE 1

An oxidized fabric (produced by Challenge Carbon Technology, Taiwan) that was plain woven with a thickness of 0.73 mm, 21 pitches/inch, 21 rows/inch, and 310 g/m², was used in this example. The oxidized fabric was immersed in a phosphoric acid solution (20 wt %) and then heated at 85° C. for 20 minutes, followed by oven exposure at 120° C. for 24 hours.

The oxidized fabric, which has been treated with the phosphoric acid solution, was placed in a tubular furnace for activation treatment. Steam was introduced into the furnace as the activating gas and argon was used to protect the two ends of the furnace. The oxidized fabric was delivered to the center of the furnace at a rate of 150° C./min. The temperature at the furnace center was 900° C. The activation treatment was conducted under 900° C. for 10 minutes. Thereafter, the fabric was moved away from the furnace center at a rate of 150° C./min. Afterwards, the resulting activated carbon fabric was washed with water for 30 minutes, and then was dried in an oven at 120° C. The resulting activated carbon fabric was tested. The properties are summarized in Table 1.

### EXAMPLE 2

The same procedures and raw materials in Example 1 were used, except that prior to the activation treatment, the oxidized fabric was immersed in a potassium hydroxide solution (0.15M) for 2 hours, and then dried in an oven under 120° C. The dried fabric was activated in the same way as described in Example 1. Moreover, after the activation treatment, the fabric was acid washed with a hydrogen chloride solution (3M) for 1 hour, and then washed with water for 2 hours, followed by oven exposure. The resulting activated carbon fabric was tested. The properties are summarized in Table 1.

### EXAMPLE 3

The same procedures and raw materials in Example 2 were used, except that prior to the activation treatment, the oxidized fabric was immersed in a potassium hydroxide solution (0.75M). The resulting activated carbon fabric was tested. The properties are summarized in Table 1.

### EXAMPLE 4

The same procedures and raw materials in Example 3 were used, except that the activation temperature was 800° C. The resulting activated carbon fabric was tested. The properties are summarized in Table 1.

### COMPARATIVE EXAMPLE 1

The same procedures and raw materials in Example 1 were used, except that prior to the activation treatment, the fabric was not treated with any chemical reagents. Also, the activation temperature was 800° C. The resulting activated carbon fabric was tested. The properties are summarized in Table 1.

### COMPARATIVE EXAMPLE 2

The same procedures and raw materials in Example 1 were used, except that prior to the activation treatment, the fabric was not treated with any chemical reagents. Also, the activation temperature was 900° C. The resulting activated carbon fabric was tested. The properties are summarized in Table 1.

### COMPARATIVE EXAMPLE 3

The same procedures and raw materials in Example 1 were used, except that prior to the activation treatment, the fabric was not treated with any chemical reagents. Also, the activation temperature was 1000° C. The resulting activated carbon fabric was tested. The properties are summarized in Table 1.

TABLE 1
Properties of the activated carbon fibers and their capacitance

| | | Specific | | | | |
|---|---|---|---|---|---|---|
| | Activation | surface | Carbon | CV | DC discharge | True |
| | temperature | area, BET | yield | capacitance | capacitance | density |
| Example | (□) | (m²/g) | (wt %) | (F/g) | (F/g) | (g/cm³) |
| Example 1 | 900 | 1011 | 24 | 139 | 124 | 1.99 |
| Example 2 | 900 | 1030 | 31 | 198 | 171 | 1.98 |
| Example 3 | 900 | 1339 | 19 | 137 | 148 | 1.99 |
| Example 4 | 800 | 1129 | 28 | 14 | 144 | 1.75 |
| Comparative | 800 | 357 | 55 | 9 | <1 | 1.79 |
| Example 1 | | | | | | |
| Comparative | 900 | 519 | 37 | 108 | 125 | 1.90 |
| Example 2 | | | | | | |
| Comparative | 1000 | 1099 | 23 | 130 | 114 | 1.98 |
| Example 3 | | | | | | |

It can be noted from Table 1 that in the absence of a chemical reagent, the resulting activated carbon fabrics has a specific surface area (a BET value) of less than 550 m²/g at an activation temperature of up to 800° C., and even up to 900° C. As a result, these fabrics are less valuable products (see Comparative Examples 1 and 2), and thus, only an activation temperature of up to 1000° C. can provide an activated carbon fabric with a BET value of above 1000 m²/g (see Comparative Example 3). However, the activation treatment that takes place in the subject invention is conducted in the presence of a chemical reagent, and thus, can provide an activated carbon fabric with a BET value of up to 1000 m²/g at a relative low activation temperature (see Examples 1 to 4 and Comparative Example 3). Furthermore, the subject invention can provide an activated carbon fabric with a higher BET value at a relatively low temperature (see Examples 3 and 4 and Comparative Example 3). As for the carbon yield, in order to produce an activated carbon fabric with a BET value of up to 1000 m²/g and higher, a higher carbon yield is achieved by using the method of the present invention at a relatively low activation temperature (see Examples 1, 2, and 4 and Comparative Example 3). As the carbon yield increases, the cost of the raw materials decreases.

Moreover, as shown in Examples 1 to 3 and Comparative Examples 4, the subject invention can provide an activated carbon fabric while keeping a relatively high CV capacitance and DC discharge capacitance at a relatively low temperature.

Given the above, the subject invention can provide a high functional activated carbon fiber product with a desired high BET value, a high carbon yield, and even a combination of high CV capacitance and DC discharge capacitance at a relative low temperature. The subject invention indeed can provide the efficacy of enhancing the manufacturing yield and economizing the energy, so as to reduce production cost and energy demand. The above-mentioned high functional activated carbon fiber product, depending on its form, can be extensively applied in environmental protection, such as waste water treatment, water purification, waste gas treatment, air filtration, and organic solvent treatment, or in food, beverage filtration, energy source, protective clothes, and molecular sieves. Furthermore, the activated carbon fabric, activated carbon fiber paper, or activated carbon fiber felt with high CV capacitance and high DC discharge capacitance is also useful for providing an electrode of an electric double layer capacitor.

The above examples are intended to illustrate the embodiments of the subject invention so as to show the technical features of the subject invention, but not to limit the scope of the subject invention. The change and equal arrangement that can be easily accomplished by persons skilled in the art are within the scope claimed by the subject invention. The scope of protection of the subject invention is based on the following claims as appended.

What is claimed is:

1. A method for manufacturing an activated carbon fiber product, comprising:
(a) providing an oxidized fiber product, and
(b) activating the oxidized fiber product in the presence of a chemical reagent selected from a group consisting of an acid, an ammonium salt, a metallic compound, and a combination thereof.

2. The method of claim 1, wherein the oxidized fiber product is in the form of fabric, felt, paper, or fiber bundle.

3. The method of claim 1, wherein the oxidized fiber in the oxidized fiber product has a limiting oxygen index of at least 40.

4. The method of claim 1, wherein the oxidized fiber product is a PAN-based oxidized fiber product.

5. The method of claim 4, wherein the PAN-based oxidized fiber product is a fireproof fabric.

6. The method of claim 1, wherein the chemical reagent is an acid selected from a group consisting of oxalic acid, phosphoric acid, carbonic acid, boric acid, sulfuric acid, and a combination thereof.

7. The method of claim 1, wherein the chemical reagent is an ammonium salt selected from a group consisting of ammonium chloride, ammonium sulfate, diammonium hydrogen phosphate, and a combination thereof.

8. The method of claim 1, wherein the chemical reagent is a metallic compound containing a metal component selected from a group consisting of potassium, sodium, calcium, manganese, chromium, iron, zinc, silver, platinum, and a combination thereof

9. The method of claim 1, wherein the metallic compound is a metal salt, a metal hydroxide, or a combination of the metal salt and the metal hydroxide.

10. The method of claim 8, wherein the salt is selected from a group consisting of a sulfate, a phosphate, a permanganate, a carbonate, a bicarbonate, a halide, and a combination thereof.

11. The method of claim 1, wherein the chemical reagent is selected from a group consisting of phosphoric acid, potassium hydroxide, zinc chloride, ammonium chloride, boric acid, ammonium sulfate, ammonium dihydrogen phosphate, potassium permanganate, potassium bicarbonate, and a combination thereof.

12. The method of claim 1, wherein the chemical reagent is phosphoric acid.

13. The method of claim 1, wherein the chemical reagent is potassium hydroxide.

14. The method of claim 1, wherein prior to step (b), an aqueous solution of the chemical reagent is used to treat the oxidized fiber product to provide the chemical reagent.

15. The method of claim 13, wherein prior to step (b), an aqueous solution of potassium hydroxide is used to immerse the oxidized fiber product to provide the chemical reagent, and after step (b), an acid is used to wash the activated carbon fiber product to neutralize the basicity remained in the fiber product.

16. The method of claim 1, wherein step (b) is conducted in the presence of an activating gas selected from a group consisting of air, carbon dioxide, steam, and a combination thereof.

17. The method of claim 16, wherein the activating gas is steam.

18. The method of claim 1, wherein step (b) is conducted under a temperature ranging from 600 to 1000° C.

19. The method of claim 1, wherein step (b) is conducted under a temperature ranging from 750 to 950° C.

20. The method of claim 1, wherein step (b) is conducted under a temperature ranging from 850 to 950° C.
